(19) United States
(12) Patent Application Publication
(10) Pub. No.: US 2022/0279572 A1
(43) Pub. Date: Sep. 1, 2022

(54) TECHNIQUES FOR CARRIER SWITCHING FOR TWO-STEP RANDOM ACCESS

(71) Applicant: QUALCOMM Incorporated, San Diego, CA (US)

(72) Inventors: Jing LEI, San Diego, CA (US); Yiqing CAO, Beijing (CN); Wanshi CHEN, San Diego, CA (US); Peter GAAL, San Diego, CA (US)

(21) Appl. No.: 17/632,160

(22) PCT Filed: Aug. 2, 2019
(86) PCT No.: PCT/CN2019/098988

§ 371 Date: Feb. 1, 2022

(51) Int. Cl. H04W 74/00; H04W 74/08

(52) U.S. Cl. CPC H04W 74/006; H04W 74/0833

(57) ABSTRACT

Various aspects of the present disclosure generally relate to wireless communication. In some aspects, a user equipment (UE) may receive configuration information identifying configurations associated with respective uplink carriers for a random access channel (RACH) message, wherein a configuration associated with a first uplink carrier, of the respective uplink carriers, is different than a configuration associated with a second uplink carrier of the respective uplink carriers. The UE may select a set of uplink carriers, of the respective uplink carriers, on which to transmit the RACH message based at least in part on the configuration information. The UE may transmit the RACH message on the selected set of uplink carriers in accordance with the configuration information. Numerous other aspects are provided.

### FIELD OF THE DISCLOSURE

Aspects of the present disclosure generally relate to wireless communication and to techniques and apparatuses for carrier switching for two-step random access.

### DESCRIPTION OF RELATED ART

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless communication network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. However, as the demand for mobile broadband access continues to increase, there exists a need for further improvements in LTE and NR technologies. Preferably, these improvements should be applicable to other multiple access technologies and the telecommunication standards that employ these technologies.

### SUMMARY

In some aspects, a method of wireless communication, performed by a user equipment (UE), may include receiving configuration information identifying configurations associated with respective uplink carriers for a random access channel (RACH) message, wherein a configuration associated with a first uplink carrier, of the respective uplink carriers, is different than a configuration associated with a second uplink carrier of the respective uplink carriers; selecting a set of uplink carriers, of the respective uplink carriers, on which to transmit the RACH message based at least in part on the configuration information; and transmitting the RACH message on the selected set of uplink carriers in accordance with the configuration information.

In some aspects, the RACH message includes a preamble and a payload. In some aspects, the preamble and the payload of the RACH message are transmitted on a same carrier of the selected set of uplink carriers.

In some aspects, the configuration information indicates at least one of payload sizes, waveforms, or numerologies associated with the respective uplink carriers. In some aspects, a payload size, a waveform, or a numerology indicated by the configuration associated with the first uplink carrier is different than a payload size, a waveform, or a numerology indicated by the configuration associated with the second uplink carrier.

In some aspects, a RACH occasion configuration indicated by the configuration associated with the first uplink carrier is different than a RACH occasion configuration indicated by the configuration associated with the second uplink carrier.

In some aspects, a resource unit configuration indicated by the configuration associated with the first uplink carrier is different than a resource unit configuration indicated by the configuration associated with the second uplink carrier.

In some aspects, a preamble of the RACH message and a payload of the RACH message are transmitted on different carriers of the selected set of uplink carriers.

In some aspects, the configurations associated with the respective uplink carriers correspond to respective transmission occasions for the RACH message on the respective uplink carriers.

In some aspects, a preamble of the RACH message and a payload of the RACH message are transmitted without a transmission gap between the preamble and the payload.

In some aspects, a preamble of the RACH message and a payload of the RACH message are transmitted with a configurable transmission gap between the preamble and the payload.

In some aspects, the selection of the selected set of uplink carriers is based at least in part on a payload size, a waveform, or a numerology of the RACH message.

In some aspects, a duty cycle indicated by the configuration associated with the first uplink carrier is different than a duty cycle indicated by the configuration associated with the second uplink carrier.

In some aspects, a transmission occasion time offset indicated by the configuration associated with the first uplink carrier is different than a transmission time offset indicated by the configuration associated with the second uplink carrier.

In some aspects, transmitting the RACH message on the selected set of uplink carriers in accordance with the configuration information further comprises transmitting the RACH message and one or more retransmissions of the RACH message on the selected set of uplink carriers.

In some aspects, transmitting the RACH message on the selected set of uplink carriers in accordance with the configuration information further comprises transmitting a preamble of the RACH message on the first uplink carrier and a payload of the RACH message on the second uplink carrier based at least in part on a multi-carrier capability of the UE.

In some aspects, the selection of the selected set of uplink carriers is based at least in part on at least one of: a coverage requirement of the UE, a power class of the UE, a radio frequency capability of the UE, or a traffic pattern of the UE.

In some aspects, the configuration information indicates a RACH occasion on an uplink carrier, of the respective uplink carriers, that is usable for a two-step RACH procedure.

In some aspects, the configuration information indicates a RACH occasion on an uplink carrier, of the respective uplink carriers, that is usable for a two-step RACH procedure and a four-step RACH procedure.

In some aspects, the selected set of uplink carriers is associated with at least one of: a supplementary uplink (SUL) configuration, a carrier aggregation configuration, or a dual-connectivity configuration.

In some aspects, the selection of the selected set of uplink carriers is based at least in part on a bias applied to a measurement on the respective uplink carriers.

In some aspects, the bias is different for selection of an uplink carrier for transmission of a preamble of the RACH message than for selection of an uplink carrier for transmission of a payload of the RACH message.

In some aspects, the bias is carrier-specific.

In some aspects, the bias is applied to the measurement based at least in part on the measurement satisfying a condition.

In some aspects, a value of the bias is based at least in part on at least one of: an uplink carrier frequency of the UE, a duplexing mode of the UE, a RACH occasion configuration of the UE, a resource unit configuration of the UE, or an interference condition associated with a carrier or cell.

In some aspects, the bias is based at least in part on a table that is signaled to the UE using at least one of system information, radio resource control signaling, or downlink control information.

In some aspects, a preamble sequence or a RACH occasion used to transmit a preamble of the RACH message indicates whether a payload of the RACH message will be transmitted on a different carrier than the preamble of the RACH message.

In some aspects, a payload of the RACH message includes a first part and a second part. In some aspects, the first part and the second part are transmitted on different uplink carriers.

In some aspects, the first part includes information identifying an uplink carrier on which the second part is transmitted.

In some aspects, the method further comprises receiving information indicating that a preamble of the RACH message is to be transmitted on a different uplink carrier than a payload of the RACH message.

In some aspects, the RACH message includes at least one of: a two-step RACH random access message, a first message of a four-step RACH procedure, or a third message of the four-step RACH procedure.

In some aspects, a method of wireless communication, performed by a base station, may include transmitting configuration information identifying configurations associated with respective uplink carriers for a RACH message, wherein a configuration associated with a first uplink carrier, of the respective uplink carriers, is different than a configuration associated with a second uplink carrier of the respective uplink carriers; and receiving the RACH message on a set of uplink carriers, of the respective uplink carriers, in accordance with the configuration information.

In some aspects, a preamble and a payload of the RACH message are received on a same carrier of the selected set of uplink carriers.

In some aspects, a payload size, a waveform, or a numerology indicated by the configuration associated with the first uplink carrier is different than a payload size, a waveform, or a numerology indicated by the configuration associated with the second uplink carrier.

In some aspects, a RACH occasion configuration indicated by the configuration associated with the first uplink carrier is different than a RACH occasion configuration indicated by the configuration associated with the second uplink carrier.

In some aspects, a resource unit configuration indicated by the configuration associated with the first uplink carrier is different than a resource unit configuration indicated by the configuration associated with the second uplink carrier.

In some aspects, the RACH message includes a preamble and a payload. In some aspects, a preamble of the RACH message and a payload of the RACH message are received on different carriers of the selected set of uplink carriers.

In some aspects, the configurations associated with the respective uplink carriers correspond to respective transmission occasions for the RACH message on the respective uplink carriers.

In some aspects, a preamble of the RACH message and a payload of the RACH message are received without a transmission gap between the preamble and the payload.

In some aspects, a preamble of the RACH message and a payload of the RACH message are received with a configurable transmission gap between the preamble and the payload.

In some aspects, a duty cycle indicated by the configuration associated with the first uplink carrier is different than a duty cycle indicated by the configuration associated with the second uplink carrier.

In some aspects, a transmission occasion time offset indicated by the configuration associated with the first uplink carrier is different than a transmission time offset indicated by the configuration associated with the second uplink carrier.

In some aspects, receiving the RACH message on the selected set of uplink carriers in accordance with the configuration information further comprises: receiving a preamble of the RACH message on the first uplink carrier and a payload of the RACH message on the second uplink carrier based at least in part on a multi-carrier capability of the UE.

In some aspects, the configuration information indicates a RACH occasion on an uplink carrier, of the respective uplink carriers, that is usable for a two-step RACH procedure.

In some aspects, the configuration information indicates a RACH occasion on an uplink carrier, of the respective uplink carriers, that is usable for a two-step RACH procedure and a four-step RACH procedure.

In some aspects, the selected set of uplink carriers is associated with at least one of: a supplementary uplink (SUL) configuration, a carrier aggregation configuration, or a dual-connectivity configuration.

In some aspects, the configuration information indicates a bias to be applied to a measurement on the respective uplink carriers for selection of the selected set of uplink carriers.

In some aspects, the bias is different for selection of an uplink carrier for transmission of a preamble of the RACH message than for selection of an uplink carrier for transmission of a payload of the RACH message.

In some aspects, a preamble sequence or a RACH occasion used to transmit a preamble of the RACH message indicates whether a payload of the RACH message will be transmitted on a different carrier than the preamble of the RACH message.

In some aspects, a payload of the RACH message includes a first part and a second part. In some aspects, the first part and the second part are received on different uplink carriers.

In some aspects, the first part includes information identifying an uplink carrier on which the second part is received.

In some aspects, the method further comprises transmitting information indicating that a preamble of the RACH message is to be transmitted on a different uplink carrier than a payload of the RACH message.

In some aspects, the RACH message includes at least one of: a two-step RACH random access message, a first message of a four-step RACH procedure, or a third message of the four-step RACH procedure.

In some aspects, a method of wireless communication, performed by a UE, may include receiving configuration information associated with a plurality of uplink carriers for a RACH message, wherein the RACH message includes a first portion and a second portion; selecting a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of: a coverage requirement of the UE, a power class of the UE, a radio frequency capability of the UE, or a traffic pattern of the UE; and transmitting the first portion of the RACH message and the second portion of the RACH message on the selected set of uplink carriers based at least in part on the configuration information.

In some aspects, a configuration associated with a first uplink carrier, of the respective uplink carriers, is different than a configuration associated with a second uplink carrier of the respective uplink carriers.

In some aspects, a UE for wireless communication may include memory and one or more processors operatively coupled to the memory. The memory and the one or more processors may be configured to receive configuration information identifying configurations associated with respective uplink carriers for a RACH message, wherein a configuration associated with a first uplink carrier, of the respective uplink carriers, is different than a configuration associated with a second uplink carrier of the respective uplink carriers; select a set of uplink carriers, of the respective uplink carriers, on which to transmit the RACH message based at least in part on the configuration information; and transmit the RACH message on the selected set of uplink carriers in accordance with the configuration information.

In some aspects, a base station for wireless communication may include memory and one or more processors operatively coupled to the memory. The memory and the one or more processors may be configured to transmit configuration information identifying configurations associated with respective uplink carriers for a RACH message, wherein a configuration associated with a first uplink carrier, of the respective uplink carriers, is different than a configuration associated with a second uplink carrier of the respective uplink carriers; and receive the RACH message on a set of uplink carriers, of the respective uplink carriers, in accordance with the configuration information.

In some aspects, a UE for wireless communication may include memory and one or more processors operatively coupled to the memory. The memory and the one or more processors may be configured to receive configuration information associated with a plurality of uplink carriers for a RACH message, wherein the RACH message includes a first portion and a second portion; select a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of: a coverage requirement of the UE, a power class of the UE, a radio frequency capability of the UE, or a traffic pattern of the UE; and transmit the first portion of the RACH message and the second portion of the RACH message on the selected set of uplink carriers based at least in part on the configuration information.

In some aspects, a non-transitory computer-readable medium may store one or more instructions for wireless communication. The one or more instructions, when executed by one or more processors of a UE, may cause the one or more processors to: receive configuration information identifying configurations associated with respective uplink carriers for a RACH message, wherein a configuration associated with a first uplink carrier, of the respective uplink carriers, is different than a configuration associated with a second uplink carrier of the respective uplink carriers; select a set of uplink carriers, of the respective uplink carriers, on which to transmit the RACH message based at least in part on the configuration information; and transmit the RACH message on the selected set of uplink carriers in accordance with the configuration information.

In some aspects, a non-transitory computer-readable medium may store one or more instructions for wireless communication. The one or more instructions, when executed by one or more processors of a UE, may cause the one or more processors to: transmit configuration information identifying configurations associated with respective uplink carriers for a RACH message, wherein a configuration associated with a first uplink carrier, of the respective uplink carriers, is different than a configuration associated with a second uplink carrier of the respective uplink carriers; and receive the RACH message on a set of uplink carriers, of the respective uplink carriers, in accordance with the configuration information.

In some aspects, a non-transitory computer-readable medium may store one or more instructions for wireless communication. The one or more instructions, when executed by one or more processors of a UE, may cause the one or more processors to: receive configuration information associated with a plurality of uplink carriers for a RACH message, wherein the RACH message includes a first portion and a second portion; select a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of: a coverage requirement of the UE, a power class of the UE, a radio frequency capability of the UE, or a traffic pattern of the UE; and transmit the first portion of the RACH message and the second portion of the RACH message on the selected set of uplink carriers based at least in part on the configuration information.

In some aspects, an apparatus for wireless communication may include means for receiving configuration information identifying configurations associated with respective uplink carriers for a RACH message, wherein a configuration associated with a first uplink carrier, of the respective uplink carriers, is different than a configuration associated with a second uplink carrier of the respective uplink carriers; means for selecting a set of uplink carriers, of the respective uplink carriers, on which to transmit the RACH message based at least in part on the configuration information; and means for transmitting the RACH message on the selected set of uplink carriers in accordance with the configuration information.

In some aspects, an apparatus for wireless communication may include means for transmitting configuration information identifying configurations associated with respective uplink carriers for a RACH message, wherein a configuration associated with a first uplink carrier, of the respective uplink carriers, is different than a configuration associated with a second uplink carrier of the respective uplink carriers; and means for receiving the RACH message on a set of uplink carriers, of the respective uplink carriers, in accordance with the configuration information.

In some aspects, an apparatus for wireless communication may include means for receiving configuration information associated with a plurality of uplink carriers for a RACH message, wherein the RACH message includes a first portion and a second portion; means for selecting a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of: a coverage requirement of the UE, a power class of the UE, a radio frequency capability of the UE, or a traffic pattern of the UE; and means for transmitting the first portion of the RACH message and the second portion of the RACH message on the selected set of uplink carriers based at least in part on the configuration information.

Aspects generally include a method, apparatus, system, computer program product, non-transitory computer-readable medium, user equipment, base station, wireless communication device, and/or processing system as substantially described with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless communication network, in accordance with various aspects of the present disclosure.

FIG. 2 is a diagram illustrating an example of a base station in communication with a UE in a wireless communication network, in accordance with various aspects of the present disclosure.

FIG. 3 is a diagram illustrating an example of a two-step random access channel (RACH) procedure, in accordance with various aspects of the present disclosure.

FIG. 4 is a diagram illustrating examples of messaging structures for RACH messages of a two-step RACH procedure, in accordance with various aspects of the present disclosure.

FIG. 5 is a diagram illustrating an example of multi-carrier configuration and transmission of a RACH message on a single carrier, in accordance with various aspects of the present disclosure.

FIG. 6 is a diagram illustrating an example of multi-carrier configuration and transmission of a RACH message on a plurality of carriers, in accordance with various aspects of the present disclosure.

FIG. 7 is a diagram illustrating an example of multi-carrier configuration and transmission of a RACH message on a time division duplexing (TDD) carrier and a supplemental uplink (SUL) carrier, in accordance with various aspects of the present disclosure.

FIG. 8 is a diagram illustrating an example of multi-carrier configuration and transmission of a RACH message on a TDD carrier and a frequency division duplexing (FDD) carrier, in accordance with various aspects of the present disclosure.

FIG. 9 is a diagram illustrating an example of an indication regarding multi-carrier transmission of a RACH message, in accordance with various aspects of the present disclosure.

FIG. 10 is a diagram illustrating an example process performed, for example, by a user equipment, in accordance with various aspects of the present disclosure.

FIG. 11 is a diagram illustrating an example process performed, for example, by a base station, in accordance with various aspects of the present disclosure.

FIG. 12 is a diagram illustrating an example process performed, for example, by a user equipment, in accordance with various aspects of the present disclosure.

FIGS. 13 and 14 are conceptual data flow diagrams illustrating the data flow between different modules/means/components in example apparatuses, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with 3G and/or 4G wireless technologies, aspects of the present disclosure can be applied in other generation-based communication systems, such as 5G and later, including NR technologies.

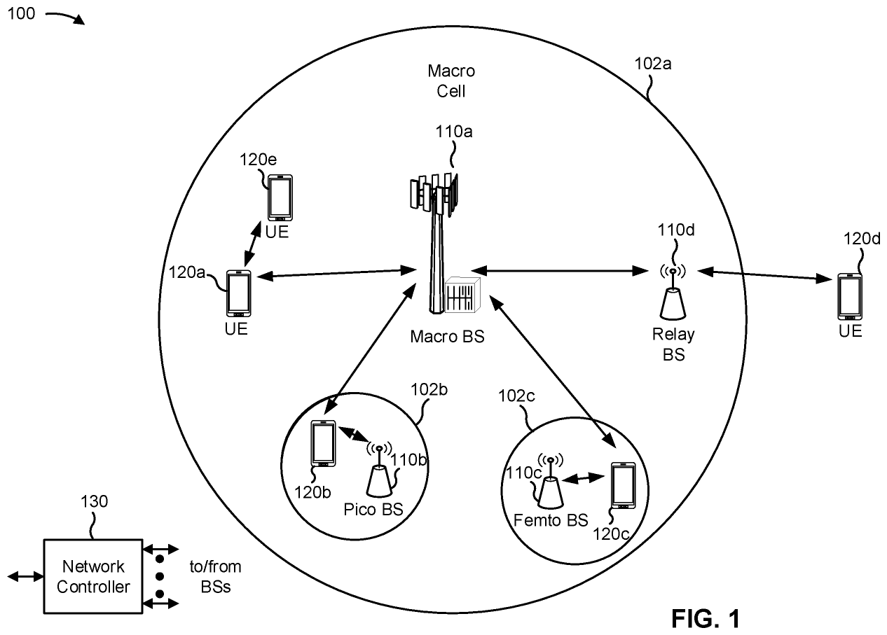

FIG. 1 is a diagram illustrating a wireless network 100 in which aspects of the present disclosure may be practiced. The wireless network 100 may be an LTE network or some other wireless network, such as a 5G or NR network. The wireless network 100 may include a number of BSs 110 (shown as BS 110a, BS 110b, BS 110c, and BS 110d) and other network entities. A BS is an entity that communicates with user equipment (UEs) and may also be referred to as a base station, an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). A BS for a macro cell may be referred to as a macro BS. A BS for a pico cell may be referred to as a pico BS. A BS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. A BS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay station 110d may communicate with macro BS 110a and a UE 120d in order to facilitate communication between BS 110a and UE 120d. A relay station may also be referred to as a relay BS, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 Watts) whereas pico BSs, femto BSs, and relay BSs may have lower transmit power levels (e.g., 0.1 to 2 Watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

As indicated above, FIG. 1 is provided as an example. Other examples may differ from what is described with regard to FIG. 1.

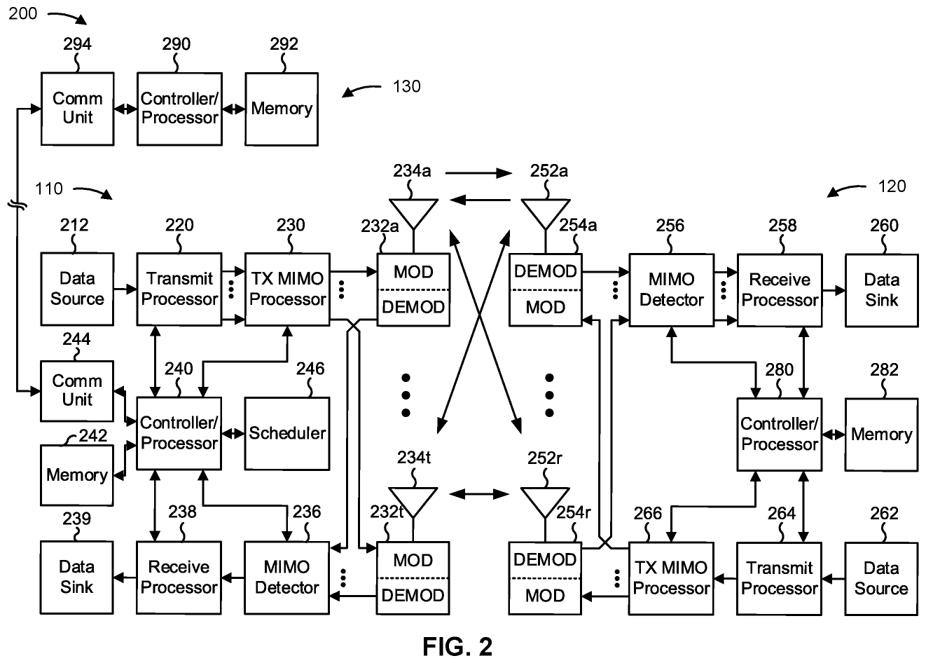

FIG. 2 shows a block diagram of a design 200 of base station 110 and UE 120, which may be one of the base stations and one of the UEs in FIG. 1. Base station 110 may be equipped with T antennas 234a through 234t, and UE 120 may be equipped with R antennas 252a through 252r, where in general T>1 and R>1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively. According to various aspects described in more detail below, the synchronization signals can be generated with location encoding to convey additional information.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing.

On the uplink, at UE 120, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Network controller 130 may include communication unit 294, controller/processor 290, and memory 292.

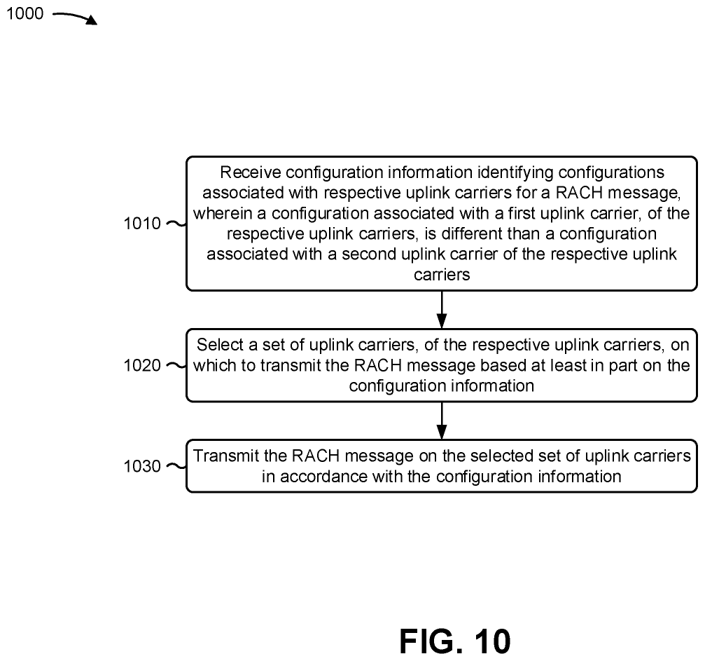

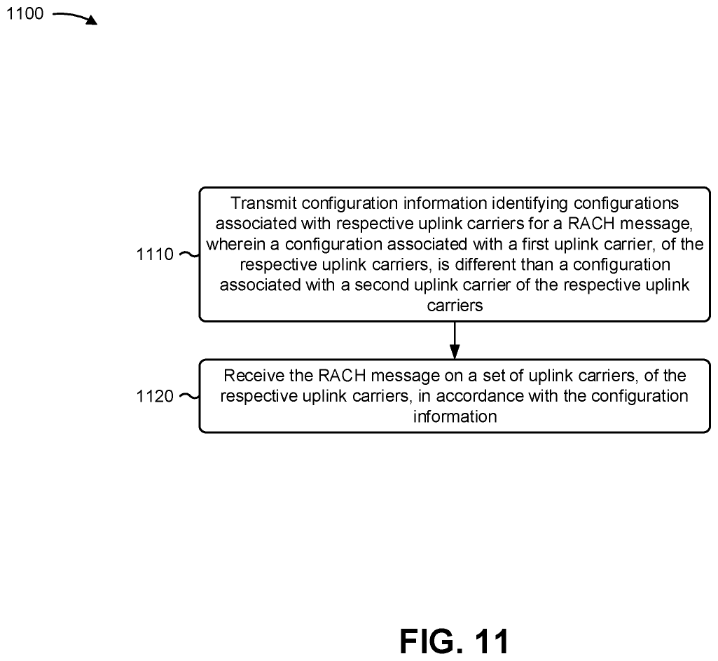

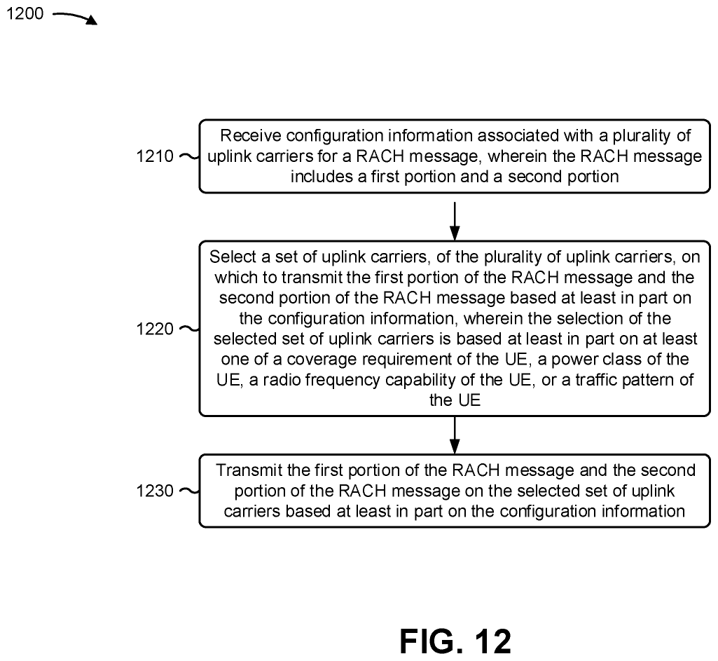

Controller/processor 240 of base station 110, controller/processor 280 of UE 120, and/or any other component(s) of FIG. 2 may perform one or more techniques associated with carrier switching for two-step random access, as described in more detail elsewhere herein. For example, controller/processor 240 of base station 110, controller/processor 280 of UE 120, and/or any other component(s) of FIG. 2 may perform or direct operations of, for example, process 1000 of FIG. 10, process 1100 of FIG. 11, process 1200 of FIG. 12, and/or other processes as described herein. Memories 242 and 282 may store data and program codes for base station 110 and UE 120, respectively. In some aspects, memory 242 and/or memory 282 may comprise a non-transitory computer-readable medium storing one or more instructions for wireless communication. For example, the one or more instructions, when executed by one or more processors of the base station 110 and/or the UE 120, may perform or direct operations of, for example, process 1000 of FIG. 10, process 1100 of FIG. 11, process 1200 of FIG. 12, and/or other processes as described herein. A scheduler 246 may schedule UEs for data transmission on the downlink and/or uplink.

In some aspects, UE 120 may include means for receiving configuration information identifying configurations associated with respective uplink carriers for a random access channel (RACH) message, wherein a configuration associated with a first uplink carrier, of the respective uplink carriers, is different than a configuration associated with a second uplink carrier of the respective uplink carriers; means for selecting a set of uplink carriers, of the respective uplink carriers, on which to transmit the RACH message based at least in part on the configuration information; means for transmitting the RACH message on the selected set of uplink carriers in accordance with the configuration information; means for transmitting the RACH message and one or more retransmissions of the RACH message on the selected set of uplink carriers; means for transmitting a preamble of the RACH message on the first uplink carrier and a payload of the RACH message on the second uplink carrier based at least in part on a multi-carrier capability of the UE; means for receiving information indicating that a preamble of the RACH message is to be transmitted on a different uplink carrier than a payload of the RACH message; means for receiving configuration information associated with a plurality of uplink carriers for a RACH message, wherein the RACH message includes a first portion and a second portion; means for selecting a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of: a coverage requirement of the UE, a power class of the UE, a radio frequency capability of the UE, or a traffic pattern of the UE; means for transmitting the first portion of the RACH message and the second portion of the RACH message on the selected set of uplink carriers based at least in part on the configuration information; and/or the like. In some aspects, such means may include one or more components of UE 120 described in connection with FIG. 2, such as controller/processor 280, transmit processor 264, TX MIMO processor 266, MOD 254, antenna 252, DEMOD 254, MIMO detector 256, receive processor 258, and/or the like.

In some aspects, base station 110 may include means for transmitting configuration information identifying configurations associated with respective uplink carriers for a RACH message, wherein a configuration associated with a first uplink carrier, of the respective uplink carriers, is different than a configuration associated with a second uplink carrier of the respective uplink carriers; means for receiving the RACH message on a set of uplink carriers, of the respective uplink carriers, in accordance with the configuration information; means for receiving a preamble of the RACH message on the first uplink carrier and a payload of the RACH message on the second uplink carrier based at least in part on a multi-carrier capability of the UE; means for transmitting information indicating that a preamble of the RACH message is to be transmitted on a different uplink carrier than a payload of the RACH message; and/or the like. In some aspects, such means may include one or more components of base station 110 described in connection with FIG. 2, such as antenna 234, DEMOD 232, MIMO detector 236, receive processor 238, controller/processor 240, transmit processor 220, TX MIMO processor 230, MOD 232, antenna 234, and/or the like.

As indicated above, FIG. 2 is provided as an example. Other examples may differ from what is described with regard to FIG. 2.

A UE may synchronize with a BS in the uplink direction by performing a random access procedure. In a random access procedure, a UE and a BS may exchange random access channels (RACHs), which are referred to herein as RACH messages. One type of random access procedure is the four-step random access procedure, in which the UE transmits a preamble in a first message (Msg1), the BS responds to the preamble in a second message (Msg2) with a grant for a third message (Msg3), the UE transmits a payload in the third message, and the BS acknowledges the third message in a fourth message (Msg4). However, four-step random access may increase latency.

A two-step random access procedure may reduce latency and signaling overhead associated with initial access and data transfer. In the two-step random access procedure, the preamble and the payload may be combined into a first message (MsgA) and the downlink communications from the base station may be combined into a second message (MsgB). The two-step random access procedure may operate in any radio resource control (RRC) state (e.g., idle, inactive, or connected). In some aspects, two-step random access may be triggered by various events, such as initial access, RRC connection reestablishment, handover, uplink resynchronization, timing alignment, a request for system information, a beam failure recovery, and/or the like. In some aspects, due to differences in channel structure, the link budgets for a preamble and a payload may be different. Therefore, transmitting the preamble and the payload on a single configured carrier may be inefficient and sub-optimal.

Some techniques and apparatuses described herein provide dynamic carrier switching for RACH message transmission. For example, some techniques and apparatuses described herein provide the configuration of multiple transmission occasions for a RACH message on different carriers. A UE may select one carrier, from the different carriers, on which to transmit the RACH message, or may select a plurality of carriers and may transmit a preamble and a payload of the RACH message on the different carriers. Furthermore, these techniques can be applied for retransmissions of RACH messages and/or payloads. Thus, load balancing via the use of different carriers is improved, throughput is increased, and coverage is improved.

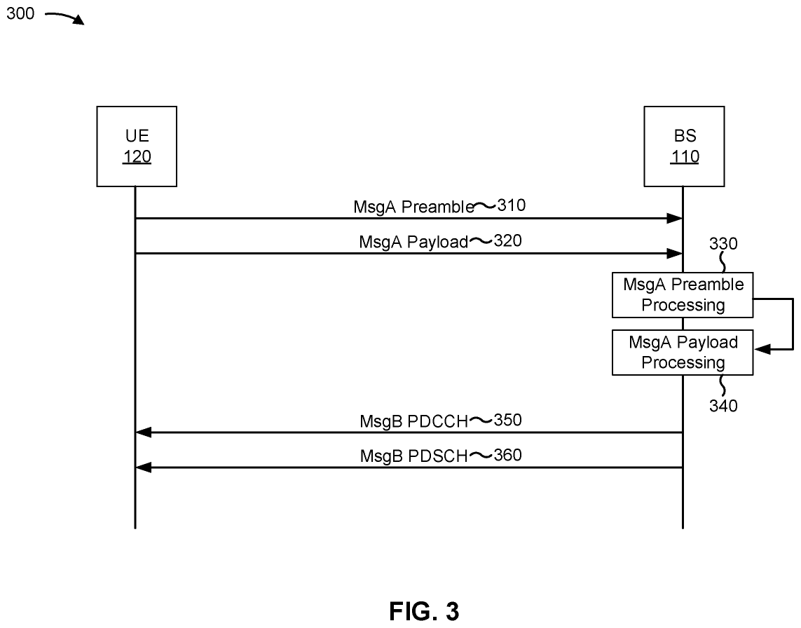

FIG. 3 is a diagram illustrating an example 300 of a two-step RACH procedure, in accordance with various aspects of the present disclosure. As shown, example 300 includes a UE 120 and a BS 110.

As shown by reference number 310, the UE 120 may transmit a MsgA preamble to the BS 110. For example, the MsgA preamble may be generated using a sequence or identifier associated with the UE 120, and may identify the UE 120 to the BS 110. As shown by reference number 320, the UE 120 may transmit a MsgA payload to the BS 110. The MsgA payload may include, for example, a demodulation reference signal (DMRS), a physical uplink shared channel (PUSCH), and/or the like.

As shown by reference number 330, the BS 110 may process the preamble. For example, the BS 110 may decode the preamble to identify the payload. As shown by reference number 340, the BS 110 may decode the payload. For example, the BS 110 may decode the PUSCH of the payload using the DMRS to determine the content of the PUSCH.

As shown by reference number 350, the BS 110 may transmit a downlink control channel (e.g., a physical downlink control channel (PDCCH)) as part of a second RACH message (e.g., MsgB). For example, the downlink control channel may identify a resource allocation for a downlink shared channel. As shown by reference number 360, the BS 110 may transmit the downlink shared channel (e.g., a physical downlink shared channel (PDSCH) and/or the like) as part of the second RACH message. For example, the BS 110 may transmit the downlink shared channel on resources indicated by the downlink control channel.

As indicated above, FIG. 3 is provided as an example. Other examples may differ from what is described with respect to FIG. 3.

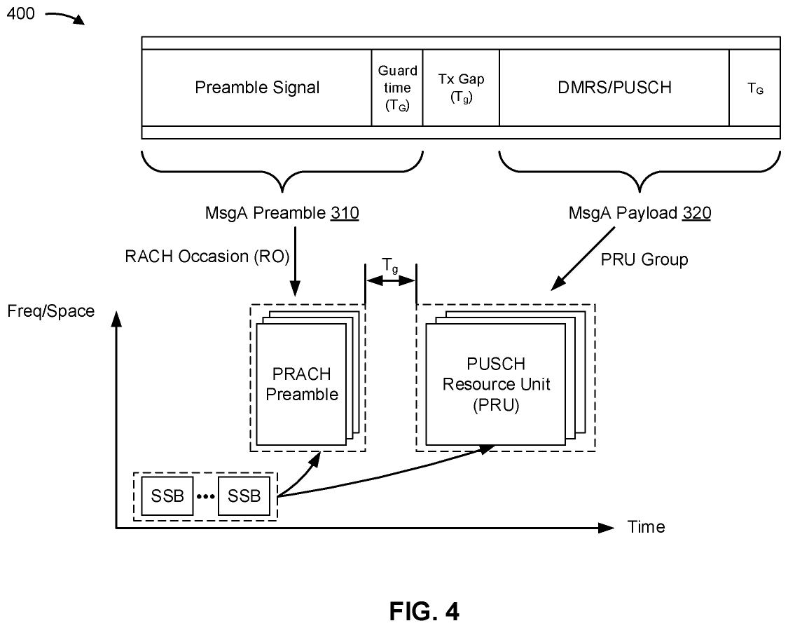

FIG. 4 is a diagram illustrating examples 400 of messaging structures for RACH messages of a two-step RACH procedure, in accordance with various aspects of the present disclosure. FIG. 4 shows additional detail regarding the MsgA preamble 310, the MsgA payload 320, the MsgB PDCCH 350, and the MsgB PDSCH 360.

As shown, the MsgA preamble 310 may include a preamble signal and a guard time (GT). The guard time may reduce interference between the MsgA preamble 310 and the MsgA payload 320. As further shown, a transmission (Tx) gap may be provided between the MsgA preamble 310 and the MsgA payload 320, which may provide for retuning from a frequency associated with the MsgA preamble 310 to a frequency associated with the MsgA payload 320. As shown, the MsgA payload 320 may include a DMRS, a PUSCH, and a guard time. In some aspects, the MsgA payload 320 may include, for example, uplink data, a medium access control (MAC) control element (CE), an uplink control information (UCI) piggybacking message, and/or the like. In some aspects, the MsgA payload 320 may be transmitted on a different carrier than the MsgA preamble 310, or on a same carrier using a different configuration than the MsgA preamble 310, as described in more detail elsewhere herein.

As shown, a plurality of MsgA preambles may map to a RACH occasion. For example, the RACH occasion may be associated with a configuration for transmitting the MsgA preamble 310. Similarly, a plurality of MsgA payloads may map to a resource unit group, such as a PUSCH resource unit (PRU) group.

As indicated above, FIG. 4 is provided as an example. Other examples may differ from what is described with respect to FIG. 4.

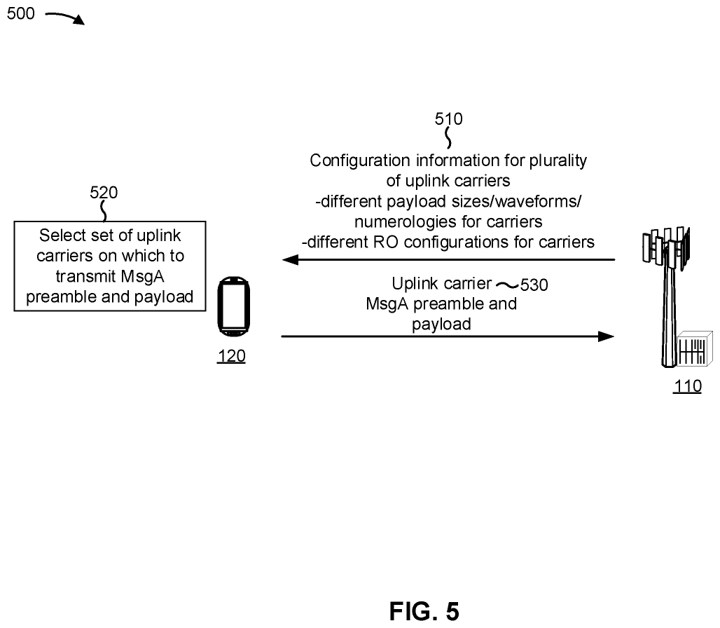

FIG. 5 is a diagram illustrating an example 500 of multi-carrier configuration and transmission of a RACH message on a single carrier, in accordance with various aspects of the present disclosure. Example 500 is an example where the UE transmits a RACH message preamble and a RACH message payload on a single uplink carrier. As shown, example 500 includes a BS 110 and a UE 120.

As shown by reference number 510, the BS 110 may provide configuration information for a plurality of uplink carriers to the UE 120. The configuration information may include information associated with a set of RACH occasions (e.g., RACH occasion configurations), a set of PRUs (e.g., PRU configurations), and/or the like. For example, the configuration information may configure a plurality of transmission occasions for a RACH message on corresponding uplink carriers. The UE 120 may use the configuration information to configure an initial transmission and/or one or more retransmissions of the RACH message on one or more transmission occasions identified by the configuration information. The configuration information may be provided using system information, radio resource control signaling, downlink control information, and/or the like. “PRU” is used interchangeably with “resource unit” herein.

In some aspects, different carriers may be configured to support different payload sizes, waveforms, and/or numerologies. For example, a first carrier may be configured to support payload sizes, waveforms, or numerologies in a first range, and a second carrier may be configured to support payload sizes, waveforms, or numerologies in a second range different than the first range. As another example, a non-supplementary uplink carrier may be associated with a payload size less than or equal to a size Q, and a supplementary uplink carrier may be associated with a payload size greater than Q. The UE 120 may select whether to transmit the payload (and/or the preamble) on the non-supplementary uplink carrier or the supplementary uplink carrier based at least in part on a payload size of the payload.

In some aspects, different carriers may be configured with different duty cycles and/or time offsets of transmission occasions for a RACH message. A duty cycle may identify a time periodicity and/or a time window in which transmission occasions are to occur. A time offset may identify a time associated with a transmission occasion relative to a reference time. The UE 120 may select a carrier on which to transmit a RACH message based at least in part on the duty cycle and/or the time offset. For example, the UE 120 may select an uplink carrier associated with a lower (e.g., less frequent) duty cycle, or may select an uplink carrier whose transmission occasions start earliest and/or with a lowest RACH latency.

As shown by reference number 520, the UE 120 may select a set of uplink carriers (e.g., one or more uplink carriers), of the plurality of uplink carriers, on which to transmit the preamble and the payload. In this example, the UE 120 selects a single uplink carrier on which to transmit the preamble and the payload. In some aspects, the UE 120 may select the set of uplink carriers based at least in part on at least one of a payload size, a waveform, a numerology, a duty cycle, a transmission occasion time offset, or a combination thereof, as described in connection with reference number 510, above. Additionally, or alternatively, the UE 120 may select the set of uplink carriers based at least in part on a coverage requirement of the UE 120 (e.g., depending on the link budget requirements for different formats of preamble and different size of payload, the UE 120 may select a first carrier configured with preamble format A and payload size less than X bytes, and may select a second carrier configured with preamble format B and payload size larger than X bytes), a power class of the UE 120 (e.g., depending on the power class of the UE 120, the UE 120 may select how to split transmit power across multiple uplink carriers), a radio frequency capability of the UE 120 (e.g., depending on the radio frequency capability of the UE 120, the UE 120 may select the transmission gap between the preamble and the payload, or the number of uplink carriers to support for CA/DC/SUL), a traffic pattern of the UE 120 (e.g., depending on the ratio of downlink and uplink packets as well as the TDD slot format, the UE 120 may select a combination of TDD and FDD carriers), and/or the like.

In some aspects, the UE 120 may determine whether the preamble and the payload are to be transmitted on a same uplink carrier or on different uplink carriers. For example, the UE 120 may determine whether a single carrier or a plurality of carriers are to be selected for transmission of the preamble and the payload. In some aspects, the UE 120 may perform this determination based at least in part on the configuration information. For example, the configuration information may include information indicating whether the UE 120 is to select a single carrier or a plurality of carriers. In some aspects, the UE 120 may determine whether a single carrier or a plurality of carriers are to be selected based at least in part on a coverage requirement of the UE 120, a power class of the UE 120, a radio frequency capability of the UE 120, a traffic pattern of the UE 120, and/or the like.

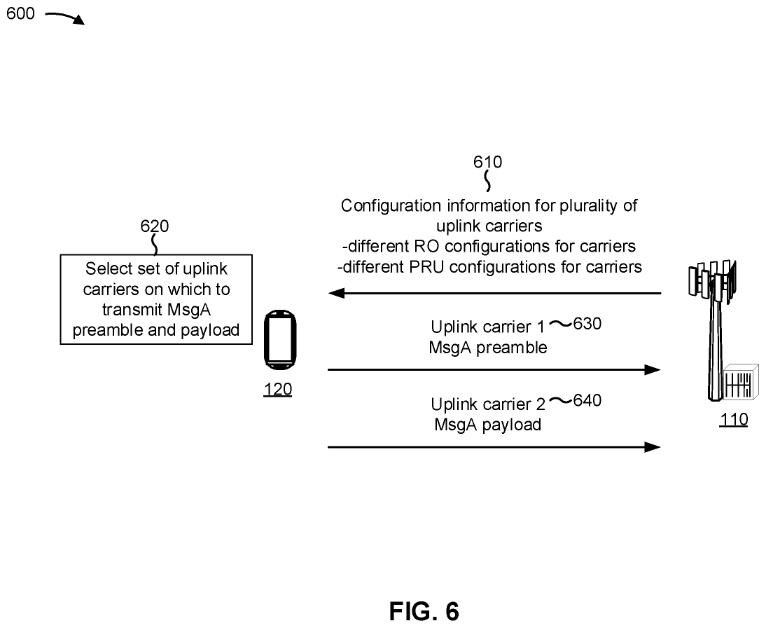

As shown by reference number 530, the UE 120 may transmit the preamble and the payload on the selected uplink carrier. For example, the UE 120 may transmit the preamble and the payload sequentially and consecutively (e.g., with no transmission gap between the preamble and the payload), or with a transmission gap (e.g., T_{g}) between the preamble and the payload. In some aspects, the UE 120 may transmit the preamble and the payload as part of a same transmission occasion. In some aspects, the UE 120 may perform a plurality of transmissions of the preamble and/or the payload. For example, the UE 120 may perform an initial transmission and/or one or more retransmissions of the preamble and/or the payload on the single carrier (or on a plurality of different carriers, as described in connection with FIG. 6). In some aspects, the one or more retransmissions may be repetitions of the initial transmission, redundancy versions based at least in part on the initial transmission, and/or the like.

As indicated above, FIG. 5 is provided as an example. Other examples may differ from what is described with respect to FIG. 5.

FIG. 6 is a diagram illustrating an example 600 of multi-carrier configuration and transmission of a RACH message on a plurality of carriers, in accordance with various aspects of the present disclosure. Example 600 is an example where a UE transmits a RACH message preamble and a RACH message payload on different uplink carriers. As shown, example 600 includes a BS 110 and a UE 120. The UE 120 may be capable of multi-carrier communication in accordance with a multi-carrier configuration, such as a supplementary uplink (SUL) configuration, a carrier aggregation (CA) configuration, a dual connectivity (DC) configuration, and/or the like.

As shown by reference number 610, the BS 110 may transmit configuration information for a plurality of uplink carriers to the UE 120. The configuration information may identify configurations for the RACH message on the plurality of uplink carriers. In some aspects, the configuration information may relate to RACH occasions on the different carriers. For example, RACH occasions on different carriers may be associated with different configurations (e.g., different physical random access channel configuration indexes, different starting frequencies, different frequency division multiplexing (FDM) configurations, different numbers of repetitions, and/or the like). In some aspects, RACH occasions on different carriers may be associated with different RACH occasion sharing statuses. For example, a RACH occasion on a first carrier may be configured to be shared between two-step RACH and four-step RACH, and a RACH occasion on a second carrier may be configured to be dedicated for two-step RACH.

In some aspects, the configuration information may relate to configurations for PRUs on the plurality of uplink carriers. For example, a configuration for a PRU on a first carrier may differ from a configuration for a PRU on a second carrier. As another example, PRUs may be configured on a single carrier, or may be configured on a plurality of carriers (e.g., for FDD carriers or for TDD carriers). In such a case, PRUs configured on different carriers may have different formats, such as different DMRS resource configurations (e.g., different resource element mapping patterns, different numbers or locations of DMRS symbols, different DMRS sequence types, different numbers of antenna ports, and/or the like), different PUSCH resource configurations (e.g., different time and/or frequency sizes, different modulation and coding schemes, different payload sizes, different rate matching configurations, different redundancy versions, different frequency hopping patterns, different numbers of repetitions, and/or the like), and/or the like.

As shown by reference number 620, the UE 120 may select a set of uplink carriers on which to transmit the preamble and the payload of the RACH message. In this case, the UE 120 selects a first uplink carrier on which to transmit the preamble, and a second uplink carrier on which to transmit the payload. In some aspects, the UE 120 may select a plurality of first uplink carriers (e.g., may transmit a plurality of preambles on the plurality of first uplink carriers) and/or a plurality of second uplink carriers (e.g., may transmit a plurality of payloads on the plurality of second uplink carriers) for transmission of the RACH message.

In some aspects, the UE 120 may select a carrier based at least in part on a bias. For example, the bias may be a carrier-specific bias, a cell-specific bias, and/or the like. In such a case, the bias may be defined as a function of one or more parameters such as an uplink carrier frequency of the carrier, a duplexing mode (e.g., TDD versus FDD), a slot format for a TDD carrier, a RACH occasion configuration, a PRU configuration, an interference associated with the carrier, and/or the like. In such a case, a table identifying bias values may be configured (e.g., preconfigured) by a network, and may be signaled to the UE 120 using system information, radio resource control signaling, downlink control information, and/or the like.

The UE 120 may apply a bias value to a measurement, such as a reference signal received power (RSRP) measurement (e.g., performed based at least in part on a synchronization signal block or a channel state information reference signal) or a different measurement. In some aspects, the UE 120 may apply the bias value based at least in part on the measurement being in a range (e.g., a preconfigured range and/or the like). For example, the range may be enabled or specified in a RACH occasion (RO) configuration and/or a PRU configuration. As an example, consider a UE that supports uplink CA on carrier A and carrier B. If carrier A is configured with more RO resources than carrier B, and if carrier A supports a PRU with a payload that satisfies a threshold (e.g., is smaller than 10 bytes, or a different threshold), then a positive bias value (e.g., greater than 0) favoring the selection of carrier A may be applied for RACH occasion selection if an RSRP measurement on carrier A is within a configured range. In such a case, the bias value may be disabled for PRU selection if the payload size fails to satisfy the threshold (e.g., is larger than 10 bytes) or if the RSRP measurement is out of the range. The bias value improves load balancing between carriers by enabling the biasing of carrier selection based at least in part on payload size, measurement values, and/or the like. Furthermore, the bias technique described above can be applied for 2-step RACH retransmissions of MsgA and for fallback from a 2-step RACH procedure to a 4-step RACH procedure.

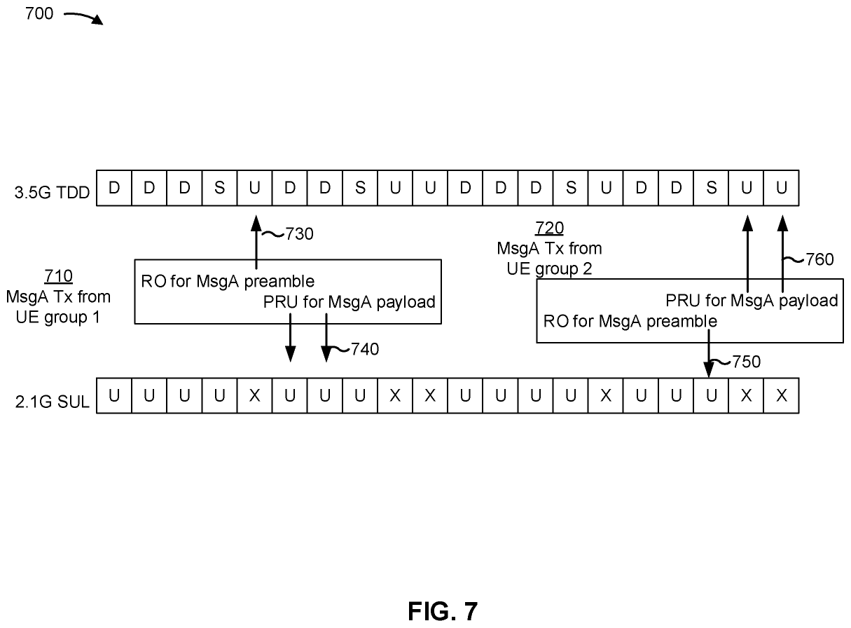

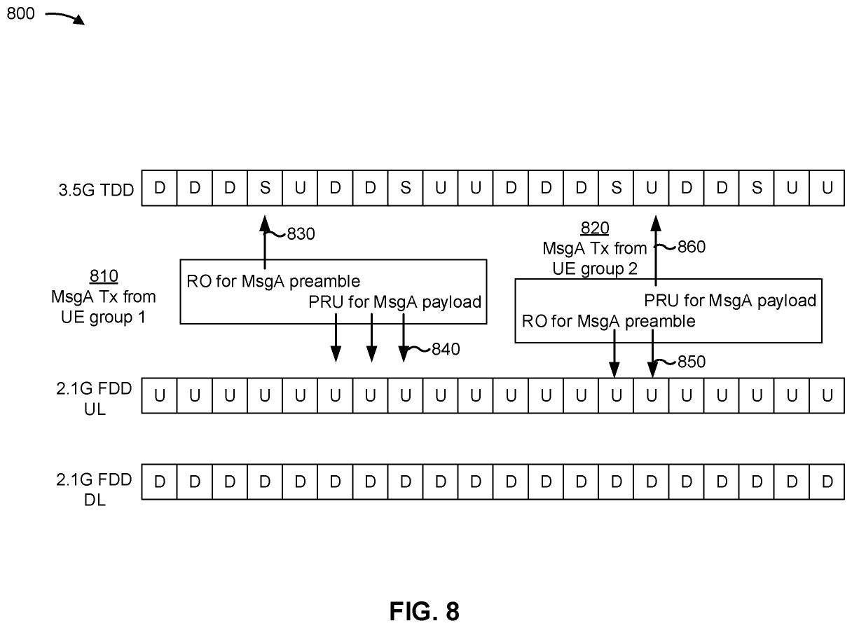

As shown by reference number 630, the UE 120 may transmit the preamble on a first uplink carrier (e.g., Uplink carrier 1) and, as shown by reference number 640, the UE 120 may transmit the payload on a second uplink carrier (e.g., Uplink carrier 2). For example, the UE 120 may transmit the preamble on a RACH occasion of the first uplink carrier indicated by the configuration information, and may transmit the payload on a PRU of the second uplink carrier indicated by the configuration information. In some aspects, the UE 120 may perform a plurality of transmissions of the preamble (e.g., on the first uplink carrier or on a plurality of uplink carriers) and/or the payload (e.g., on the second uplink carrier or on a plurality of uplink carriers). For a more detailed description of transmission of the preamble and payload on a plurality of uplink carriers in SUL, CA, and DC configurations, refer to FIGS. 7 and 8, below.

As indicated above, FIG. 6 is provided as an example. Other examples may differ from what is described with respect to FIG. 6.

FIG. 7 is a diagram illustrating an example 700 of multi-carrier configuration and transmission of a RACH message on a TDD carrier and a supplementary uplink (SUL) carrier, in accordance with various aspects of the present disclosure. As shown, example 700 includes a TDD carrier (e.g., associated with a frequency of 3.5 GHz) and an SUL carrier (e.g., associated with a frequency of 2.1 GHz). Symbols or slots are indicated by squares. The horizontal direction represents time. “U” indicates an uplink slot or symbol. “D” indicates a downlink slot or symbol. “S” indicates a special slot or symbol. “X” indicates that the SUL cannot carry uplink traffic in the corresponding slot or symbol since the TDD carrier is associated with an uplink slot or symbol that overlaps the corresponding slot or symbol.

A first transmission of a RACH message (e.g., MsgA) by a first UE group (e.g., UE group 1) is shown by reference number 710. A second transmission of a RACH message by a second UE group is shown by reference number 720. As shown by reference number 730, a RACH occasion for a preamble of the first transmission may be on the TDD carrier. As shown by reference number 740, one or more PRUs for a payload of the first transmission may be on the SUL carrier. For example, a UE 120 of the first UE group may select the first carrier for the preamble and the second carrier for the payload, as described elsewhere herein. In some aspects, the UE 120 may select the RACH occasion and/or the PRU (e.g., based at least in part on the TDD configuration of the TDD carrier and/or the like).

As shown by reference number 750, the second UE group may transmit the preamble on an uplink slot or symbol of the SUL carrier and, as shown by reference number 760, the second UE group may transmit the payload on one or more slots or symbols of the TDD carrier. For example, a UE 120 of the second UE group may select the SUL carrier for transmission of the preamble and the TDD carrier for transmission of the payload. In some aspects, the UEs 120 of the first UE group and/or the second UE group may select the carriers using a bias, described elsewhere herein, which may improve load balancing on the carriers between the UE groups.

As indicated above, FIG. 7 is provided as an example. Other examples may differ from what is described with respect to FIG. 7.

FIG. 8 is a diagram illustrating an example 800 of multi-carrier configuration and transmission of a RACH message on a TDD carrier and an FDD carrier, in accordance with various aspects of the present disclosure. For example, the operations described in connection with FIG. 8 may be performed by a UE 120 capable of carrier aggregation. As shown, example 800 includes a TDD carrier (e.g., associated with a frequency of 3.5 GHz) and an FDD carrier (e.g., associated with a frequency of 2.1 GHz). A first transmission of a RACH message (e.g., MsgA) by a first UE group (e.g., UE group 1) is shown by reference number 810. A second transmission of a RACH message by a second UE group is shown by reference number 820. As shown by reference number 830, a RACH occasion for a preamble of the first transmission may be on the TDD carrier. As shown by reference number 840, one or more PRUs for a payload of the first transmission may be on the TDD carrier. For example, a UE 120 of the first UE group may select the first carrier for the preamble and the second carrier for the payload, as described elsewhere herein. In some aspects, the UE 120 may select the RACH occasion and/or the PRU (e.g., based at least in part on the TDD configuration of the TDD carrier and/or the like).

As shown by reference number 850, the second UE group may transmit the preamble on the FDD carrier and, as shown by reference number 860, the second UE group may transmit the payload on one or more slots or symbols of the TDD carrier. As shown, the second UE group may transmit the preamble and the payload concurrently. For example, the FDD carrier may be configured with a RO that overlaps a PRU of the TDD carrier in time. A CA-capable UE 120 may be capable of concurrent communication on the TDD carrier and the FDD carrier, which may enable concurrent transmission of the preamble and the payload, thereby reducing latency associated with the two-step RACH procedure.

As indicated above, FIG. 8 is provided as an example. Other examples may differ from what is described with respect to FIG. 8.

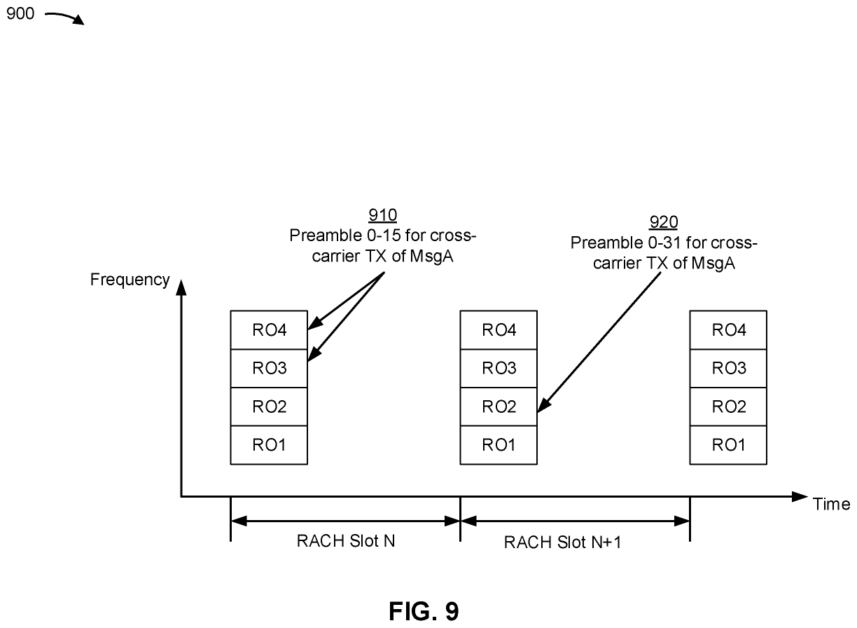

FIG. 9 is a diagram illustrating an example 900 of an indication regarding multi-carrier transmission of a RACH message, in accordance with various aspects of the present disclosure. In some aspects, the UE 120 may indicate that the UE 120 is to perform cross-carrier transmission of the RACH message (e.g., that the UE 120 is to transmit the preamble on a first carrier and the payload on a second carrier). In some aspects, the UE 120 may provide the indication using preamble resource partitioning. For example, the UE 120 may transmit a preamble using a preamble sequence (e.g., a preamble sequence from a set of preconfigured preamble sequences) on a RACH occasion (e.g., a RACH occasion from a set of preconfigured RACH occasions) to indicate that the UE 120 is to perform cross-carrier transmission of the RACH message. For example, refer to reference numbers 910 and 920 of FIG. 9. As shown by reference number 910, the UE 120 may use preamble sequences 0 through 15 in ROs 3 and 4 to indicate that the UE 120 is to perform cross-carrier transmission of the RACH message in RACH slot N. As shown by reference number 920, the UE 120 may use preamble sequences 0 through 31 to indicate that the UE 120 is to perform cross-carrier transmission of the RACH message in RACH slot N+1.

In some aspects, a payload of the RACH message may indicate that the UE 120 is to perform cross-carrier transmission of the RACH message. For example, the payload may use a two-part or two-stage PRU, wherein the two parts are configured on different carriers. In this case, a first part of the PRU may carry a portion of the payload (e.g., on the same carrier as the preamble). The portion of the payload may include, for example, a UE identifier, a pointer to a configuration of a second part of the PRU, and/or the like. For example, the pointer to the configuration of the second part may indicate a resource allocation for the second part, a PRU for the second part, and/or the like. The second part may carry a remainder of the payload.

In some aspects, the UE 120 may receive information indicating whether the UE 120 is to perform cross-carrier scheduling. For example, the UE 120 may receive downlink control information (e.g., for contention-free random access), a configured grant (e.g., for contention-based random access), and/or the like indicating whether the UE 120 is to perform cross-carrier scheduling. In this case, the DCI or configured grant may include a field, such as a carrier indication field, indicating whether the UE 120 is to perform cross-carrier transmission of the RACH message.

As indicated above, FIG. 9 is provided as an example. Other examples may differ from what is described with respect to FIG. 9.

FIG. 10 is a diagram illustrating an example process 1000 performed, for example, by a UE, in accordance with various aspects of the present disclosure. Example process 1000 is an example where a UE (e.g., UE 120 and/or the like) performs operations associated with techniques for carrier switching for two-step random access.

As shown in FIG. 10, in some aspects, process 1000 may include receiving configuration information identifying configurations associated with respective uplink carriers for a RACH message, wherein a configuration associated with a first uplink carrier, of the respective uplink carriers, is different than a configuration associated with a second uplink carrier of the respective uplink carriers (block 1010). For example, the UE (e.g., using antenna 252, DEMOD 254, MIMO detector 256, receive processor 258, controller/processor 280, and/or the like) may receive configuration information identifying configurations associated with respective uplink carriers for a RACH message, as described above. In some aspects, a configuration associated with a first uplink carrier, of the respective uplink carriers, is different than a configuration associated with a second uplink carrier of the respective uplink carriers.

As further shown in FIG. 10, in some aspects, process 1000 may include selecting a set of uplink carriers, of the respective uplink carriers, on which to transmit the RACH message based at least in part on the configuration information (block 1020). For example, the UE (e.g., using antenna 252, DEMOD 254, MIMO detector 256, receive processor 258, controller/processor 280, and/or the like) may select a set of uplink carriers, of the respective uplink carriers, on which to transmit the RACH message based at least in part on the configuration information, as described above.

As further shown in FIG. 10, in some aspects, process 1000 may include transmitting the RACH message on the selected set of uplink carriers in accordance with the configuration information (block 1030). For example, the UE (e.g., using controller/processor 280, transmit processor 264, TX MIMO processor 266, MOD 254, antenna 252, and/or the like) may transmit the RACH message on the selected set of uplink carriers in accordance with the configuration information, as described above.

Process 1000 may include additional aspects, such as any single aspect or any combination of aspects described below and/or in connection with one or more other processes described elsewhere herein.

In a first aspect, the RACH message includes a preamble and a payload. In some aspects, the preamble and the payload of the RACH message are transmitted on a same carrier of the selected set of uplink carriers.

In a second aspect, alone or in combination with the first aspect, the configuration information indicates at least one of payload sizes, waveforms, or numerologies associated with the respective uplink carriers. In some aspects, a payload size, a waveform, or a numerology indicated by the configuration associated with the first uplink carrier is different than a payload size, a waveform, or a numerology indicated by the configuration associated with the second uplink carrier.

In a third aspect, alone or in combination with one or more of the first and second aspects, a RACH occasion configuration indicated by the configuration associated with the first uplink carrier is different than a RACH occasion configuration indicated by the configuration associated with the second uplink carrier.

In a fourth aspect, alone or in combination with one or more of the first through third aspects, a resource unit configuration indicated by the configuration associated with the first uplink carrier is different than a resource unit configuration indicated by the configuration associated with the second uplink carrier.

In a fifth aspect, alone or in combination with one or more of the first through fourth aspects, a preamble of the RACH message and a payload of the RACH message are transmitted on different carriers of the selected set of uplink carriers.

In a sixth aspect, alone or in combination with one or more of the first through fifth aspects, the configurations associated with the respective uplink carriers correspond to respective transmission occasions for the RACH message on the respective uplink carriers.

In a seventh aspect, alone or in combination with one or more of the first through sixth aspects, a preamble of the RACH message and a payload of the RACH message are transmitted without a transmission gap between the preamble and the payload.

In an eighth aspect, alone or in combination with one or more of the first through seventh aspects, a preamble of the RACH message and a payload of the RACH message are transmitted with a configurable transmission gap between the preamble and the payload.

In a ninth aspect, alone or in combination with one or more of the first through eighth aspects, the selection of the selected set of uplink carriers is based at least in part on a payload size, a waveform, or a numerology of the RACH message.

In a tenth aspect, alone or in combination with one or more of the first through ninth aspects, a duty cycle indicated by the configuration associated with the first uplink carrier is different than a duty cycle indicated by the configuration associated with the second uplink carrier.

In an eleventh aspect, alone or in combination with one or more of the first through tenth aspects, a transmission occasion time offset indicated by the configuration associated with the first uplink carrier is different than a transmission time offset indicated by the configuration associated with the second uplink carrier.

In a twelfth aspect, alone or in combination with one or more of the first through eleventh aspects, transmitting the RACH message on the selected set of uplink carriers in accordance with the configuration information further comprises transmitting the RACH message and one or more retransmissions of the RACH message on the selected set of uplink carriers.

In a thirteenth aspect, alone or in combination with one or more of the first through twelfth aspects, transmitting the RACH message on the selected set of uplink carriers in accordance with the configuration information further comprises transmitting a preamble of the RACH message on the first uplink carrier and a payload of the RACH message on the second uplink carrier based at least in part on a multi-carrier capability of the UE.

In a fourteenth aspect, alone or in combination with one or more of the first through thirteenth aspects, the selection of the selected set of uplink carriers is based at least in part on at least one of: a coverage requirement of the UE, a power class of the UE, a radio frequency capability of the UE, or a traffic pattern of the UE.

In a fifteenth aspect, alone or in combination with one or more of the first through fourteenth aspects, the configuration information indicates a RACH occasion on an uplink carrier, of the respective uplink carriers, that is usable for a two-step RACH procedure.

In a sixteenth aspect, alone or in combination with one or more of the first through fifteenth aspects, the configuration information indicates a RACH occasion on an uplink carrier, of the respective uplink carriers, that is usable for a two-step RACH procedure and a four-step RACH procedure.

In a seventeenth aspect, alone or in combination with one or more of the first through sixteenth aspects, the selected set of uplink carriers is associated with at least one of: a supplementary uplink (SUL) configuration, a carrier aggregation configuration, or a dual-connectivity configuration.

In an eighteenth aspect, alone or in combination with one or more of the first through seventeenth aspects, the selection of the selected set of uplink carriers is based at least in part on a bias applied to a measurement on the respective uplink carriers.

In a nineteenth aspect, alone or in combination with one or more of the first through eighteenth aspects, the bias is different for selection of an uplink carrier for transmission of a preamble of the RACH message than for selection of an uplink carrier for transmission of a payload of the RACH message.

In a twentieth aspect, alone or in combination with one or more of the first through nineteenth aspects, the bias is carrier-specific.

In a twenty-first aspect, alone or in combination with one or more of the first through twentieth aspects, the bias is applied to the measurement based at least in part on the measurement satisfying a condition.

In a twenty-second aspect, alone or in combination with one or more of the first through twenty-first aspects, a value of the bias is based at least in part on at least one of: an uplink carrier frequency of the UE, a duplexing mode of the UE, a RACH occasion configuration of the UE, a resource unit configuration of the UE, or an interference condition associated with a carrier or cell.

In a twenty-third aspect, alone or in combination with one or more of the first through twenty-second aspects, the bias is based at least in part on a table that is signaled to the UE using at least one of system information, radio resource control signaling, or downlink control information.

In a twenty-fourth aspect, alone or in combination with one or more of the first through twenty-third aspects, a preamble sequence or a RACH occasion used to transmit a preamble of the RACH message indicates whether a payload of the RACH message will be transmitted on a different carrier than the preamble of the RACH message.

In a twenty-fifth aspect, alone or in combination with one or more of the first through twenty-fourth aspects, a payload of the RACH message includes a first part and a second part. In some aspects, the first part and the second part are transmitted on different uplink carriers.

In a twenty-sixth aspect, alone or in combination with one or more of the first through twenty-fifth aspects, the first part includes information identifying an uplink carrier on which the second part is transmitted.

In a twenty-seventh aspect, alone or in combination with one or more of the first through twenty-sixth aspects, the method further comprises receiving information indicating that a preamble of the RACH message is to be transmitted on a different uplink carrier than a payload of the RACH message.

In a twenty-eighth aspect, alone or in combination with one or more of the first through twenty-seventh aspects, the RACH message includes at least one of: a two-step RACH random access message, a first message of a four-step RACH procedure, or a third message of the four-step RACH procedure.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with various aspects of the present disclosure. Example process 1100 is an example where a base station (e.g., base station 110 and/or the like) performs operations associated with techniques for carrier switching for two-step random access.

As shown in FIG. 11, in some aspects, process 1100 may include transmitting configuration information identifying configurations associated with respective uplink carriers for a RACH message, wherein a configuration associated with a first uplink carrier, of the respective uplink carriers, is different than a configuration associated with a second uplink carrier of the respective uplink carriers (block 1110). For example, the base station (e.g., using controller/processor 240, transmit processor 220, TX MIMO processor 230, MOD 232, antenna 234, and/or the like) may transmit configuration information identifying configurations associated with respective uplink carriers for a RACH message, as described above. In some aspects, a configuration associated with a first uplink carrier, of the respective uplink carriers, is different than a configuration associated with a second uplink carrier of the respective uplink carriers.

As further shown in FIG. 11, in some aspects, process 1100 may include receiving the RACH message on a set of uplink carriers, of the respective uplink carriers, in accordance with the configuration information (block 1120). For example, the base station (e.g., using antenna 234, DEMOD 232, MIMO detector 236, receive processor 238, controller/processor 240, and/or the like) may receive the RACH message on a set of uplink carriers, of the respective uplink carriers, in accordance with the configuration information, as described above.

Process 1100 may include additional aspects, such as any single aspect or any combination of aspects described below and/or in connection with one or more other processes described elsewhere herein.

In a first aspect, a preamble and a payload of the RACH message are received on a same carrier of the selected set of uplink carriers.

In a second aspect, alone or in combination with the first aspect, a payload size, a waveform, or a numerology indicated by the configuration associated with the first uplink carrier is different than a payload size, a waveform, or a numerology indicated by the configuration associated with the second uplink carrier.

In a third aspect, alone or in combination with one or more of the first and second aspects, a RACH occasion configuration indicated by the configuration associated with the first uplink carrier is different than a RACH occasion configuration indicated by the configuration associated with the second uplink carrier.

In a fourth aspect, alone or in combination with one or more of the first through third aspects, a resource unit configuration indicated by the configuration associated with the first uplink carrier is different than a resource unit configuration indicated by the configuration associated with the second uplink carrier.

In a fifth aspect, alone or in combination with one or more of the first through fourth aspects, the RACH message includes a preamble and a payload. In some aspects, a preamble of the RACH message and a payload of the RACH message are received on different carriers of the selected set of uplink carriers.

In a sixth aspect, alone or in combination with one or more of the first through fifth aspects, the configurations associated with the respective uplink carriers correspond to respective transmission occasions for the RACH message on the respective uplink carriers.

In a seventh aspect, alone or in combination with one or more of the first through sixth aspects, a preamble of the RACH message and a payload of the RACH message are received without a transmission gap between the preamble and the payload.

In an eighth aspect, alone or in combination with one or more of the first through seventh aspects, a preamble of the RACH message and a payload of the RACH message are received with a configurable transmission gap between the preamble and the payload.

In a ninth aspect, alone or in combination with one or more of the first through eighth aspects, a duty cycle indicated by the configuration associated with the first uplink carrier is different than a duty cycle indicated by the configuration associated with the second uplink carrier.

In a tenth aspect, alone or in combination with one or more of the first through ninth aspects, a transmission occasion time offset indicated by the configuration associated with the first uplink carrier is different than a transmission time offset indicated by the configuration associated with the second uplink carrier.

In an eleventh aspect, alone or in combination with one or more of the first through tenth aspects, receiving the RACH message on the selected set of uplink carriers in accordance with the configuration information further comprises receiving a preamble of the RACH message on the first uplink carrier and a payload of the RACH message on the second uplink carrier based at least in part on a multi-carrier capability of the UE.

In a twelfth aspect, alone or in combination with one or more of the first through eleventh aspects, the configuration information indicates a RACH occasion on an uplink carrier, of the respective uplink carriers, that is usable for a two-step RACH procedure.

In a thirteenth aspect, alone or in combination with one or more of the first through twelfth aspects, the configuration information indicates a RACH occasion on an uplink carrier, of the respective uplink carriers, that is usable for a two-step RACH procedure and a four-step RACH procedure.

In a fourteenth aspect, alone or in combination with one or more of the first through thirteenth aspects, the selected set of uplink carriers is associated with at least one of: a supplementary uplink (SUL) configuration, a carrier aggregation configuration, or a dual-connectivity configuration.

In a fifteenth aspect, alone or in combination with one or more of the first through fourteenth aspects, the configuration information indicates a bias to be applied to a measurement on the respective uplink carriers for selection of the selected set of uplink carriers.

In a sixteenth aspect, alone or in combination with one or more of the first through fifteenth aspects, the bias is different for selection of an uplink carrier for transmission of a preamble of the RACH message than for selection of an uplink carrier for transmission of a payload of the RACH message.

In a seventeenth aspect, alone or in combination with one or more of the first through sixteenth aspects, a preamble sequence or a RACH occasion used to transmit a preamble of the RACH message indicates whether a payload of the RACH message will be transmitted on a different carrier than the preamble of the RACH message.

In an eighteenth aspect, alone or in combination with one or more of the first through seventeenth aspects, a payload of the RACH message includes a first part and a second part. In some aspects, the first part and the second part are received on different uplink carriers.

In a nineteenth aspect, alone or in combination with one or more of the first through eighteenth aspects, the first part includes information identifying an uplink carrier on which the second part is received.

In a twentieth aspect, alone or in combination with one or more of the first through nineteenth aspects, the method further comprises transmitting information indicating that a preamble of the RACH message is to be transmitted on a different uplink carrier than a payload of the RACH message.

In a twenty-first aspect, alone or in combination with one or more of the first through twentieth aspects, the RACH message includes at least one of: a two-step RACH random access message, a first message of a four-step RACH procedure, or a third message of the four-step RACH procedure.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a user equipment, in accordance with various aspects of the present disclosure. Example process 1200 is an example where a UE (e.g., UE 120 and/or the like) performs operations associated with techniques for carrier switching for two-step random access.

As shown in FIG. 12, in some aspects, process 1200 may include receiving configuration information associated with a plurality of uplink carriers for a RACH message, wherein the RACH message includes a first portion and a second portion (block 1210). For example, the UE (e.g., using antenna 252, DEMOD 254, MIMO detector 256, receive processor 258, controller/processor 280, and/or the like) may receive configuration information associated with a plurality of uplink carriers for a random access channel (RACH) message, as described above. In some aspects, the RACH message includes a first portion (e.g., a first part, a preamble, and/or the like) and a second portion (e.g., a second part, a payload, and/or the like).

As further shown in FIG. 12, in some aspects, process 1200 may include selecting a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of a coverage requirement of the UE, a power class of the UE, a radio frequency capability of the UE, or a traffic pattern of the UE (block 1220). For example, the UE (e.g., using antenna 252, DEMOD 254, MIMO detector 256, receive processor 258, controller/processor 280, and/or the like) may select a set of uplink carriers, of the plurality of uplink carriers, on which to transmit the first portion of the RACH message and the second portion of the RACH message. In some aspects, the selection of the selected set of uplink carriers is based at least in part on at least one of: a coverage requirement of the UE, a power class of the UE, a radio frequency capability of the UE, or a traffic pattern of the UE.

As further shown in FIG. 12, in some aspects, process 1200 may include transmitting the first portion of the RACH message and the second portion of the RACH message on the selected set of uplink carriers based at least in part on the configuration information (block 1230). For example, the UE (e.g., using controller/processor 280, transmit processor 264, TX MIMO processor 266, MOD 254, antenna 252, and/or the like) may transmit the first portion of the RACH message and the second portion of the RACH message on the selected set of uplink carriers based at least in part on the configuration information, as described above.

Process 1200 may include additional aspects, such as any single aspect or any combination of aspects described below and/or in connection with one or more other processes described elsewhere herein (e.g., such as process 1000).

In some aspects, a configuration associated with a first uplink carrier, of the respective uplink carriers, is different than a configuration associated with a second uplink carrier of the respective uplink carriers.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

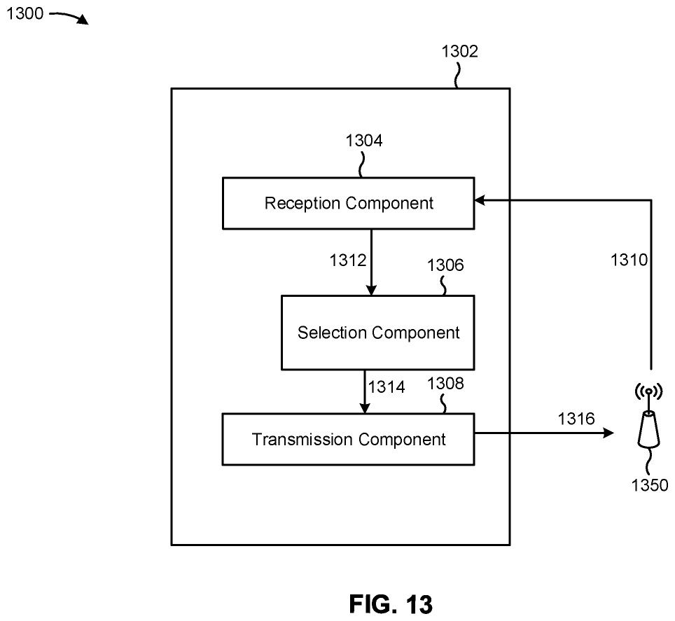

FIG. 13 is a conceptual data flow diagram 1300 illustrating the data flow between different modules/means/components in an example apparatus 1302. The apparatus 1302 may be a UE (e.g., UE 120). In some aspects, the apparatus 1302 includes a reception component 1304, a selection component 1306, and/or a transmission component 1308.

The reception component 1304 may receive signals 1310 from a BS 1350 (e.g., BS 110). The signals 1310 may include configuration information identifying configurations associated with respective uplink carriers for a random access channel on at least one of the plurality of carriers, information indicating that a preamble of the RACH message is to be transmitted on a different uplink carrier than a payload of the RACH message, and/or the like. The reception component 1304 may provide data 1312 to the selection component 1306.

The selection component 1306 may select a set of uplink carriers, of the respective uplink carriers, on which to transmit the RACH message based at least in part on the configuration information. In some aspects, the selection component 1306 may select the set of uplink carriers based at least in part on at least one of: a coverage requirement of the apparatus 1302, a power class of the apparatus 1302, a radio frequency capability of the apparatus 1302, or a traffic pattern of the apparatus 1302. The selection component 1306 may provide data 1314 to the transmission component 1308. The data 1314 may indicate the set of uplink carriers. The transmission component 1308 may transmit the RACH message as signals 1316 on the selected set of uplink carriers in accordance with the configuration information. In some aspects, the transmission component 1308 may transmit a preamble of the RACH message on the first uplink carrier and a payload of the RACH message on the second uplink carrier based at least in part on a multi-carrier capability of the apparatus 1302.

The apparatus 1302 may include additional components that perform each of the blocks of the algorithm in the aforementioned process 1000 of FIG. 10, process 1200 of FIG. 12, and/or the like. Each block in the aforementioned process 1000 of FIG. 10, process 1200 of FIG. 12, and/or the like may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of components (e.g., one or more components) shown in FIG. 13 may perform one or more functions described as being performed by another set of components shown in FIG. 13.

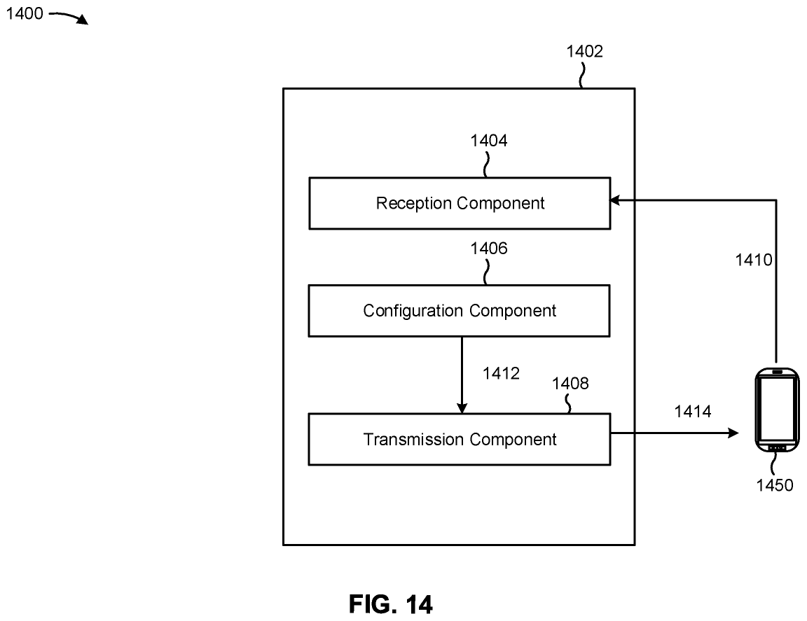

FIG. 14 is a conceptual data flow diagram 1400 illustrating the data flow between different modules/means/components in an example apparatus 1402. The apparatus 1402 may be a BS (e.g., BS 110). In some aspects, the apparatus 1402 includes a reception component 1404, a configuration component 1406, and/or a transmission component 1408.

The reception component 1404 may receive signals 1408 from a UE 1450 (e.g., UE 120). The signals 1408 may include a RACH message on a set of uplink carriers, of respective uplink carriers, in accordance with configuration information. In some aspects, the signals 1408 may include an indication that the UE 1450 is to perform cross-carrier transmission of the RACH message. The configuration component 1406 may configure resources (e.g., RACH occasions, PSU resources, and/or the like) for various carriers. The configuration component 1406 may provide data 1412 to the transmission component 1408. For example, the data 1412 may include configuration information identifying configurations associated with respective uplink carriers for a RACH message. The transmission component 1408 may transmit signals 1414 to the UE 1450. The signals 1414 may include, for example, configuration information identifying configurations associated with respective uplink carriers for a RACH message, wherein a configuration associated with a first uplink carrier, of the respective uplink carriers, is different than a configuration associated with a second uplink carrier of the respective uplink carriers, and/or the like.

The apparatus 1402 may include additional components that perform each of the blocks of the algorithm in the aforementioned process 1100 of FIG. 11 and/or the like. Each block in the aforementioned process 1100 of FIG. 11 and/or the like may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of components (e.g., one or more components) shown in FIG. 14 may perform one or more functions described as being performed by another set of components shown in FIG. 14.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of components (e.g., one or more components) shown in FIG. 15 may perform one or more functions described as being performed by another set of components shown in FIG. 15.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items, and may be used interchangeably with “one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise.

1. A method of wireless communication performed by a user equipment (UE), comprising:
receiving configuration information identifying configurations associated with respective uplink carriers for a random access channel (RACH) message, wherein a configuration associated with a first uplink carrier, of the respective uplink carriers, is different than a configuration associated with a second uplink carrier of the respective uplink carriers;
selecting a set of uplink carriers, of the respective uplink carriers, on which to transmit the RACH message based at least in part on the configuration information; and
transmitting the RACH message on the selected set of uplink carriers in accordance with the configuration information.

2. The method of claim 1, wherein the RACH message includes a preamble and a payload, and wherein the preamble and the payload of the RACH message are transmitted on a same carrier of the selected set of uplink carriers.

3. The method of claim 1, wherein the configuration information indicates at least one of payload sizes, waveforms, or numerologies associated with the respective uplink carriers, and wherein a payload size, a waveform, or a numerology indicated by the configuration associated with the first uplink carrier is different than a payload size, a waveform, or a numerology indicated by the configuration associated with the second uplink carrier.

4. The method of claim 1, wherein a RACH occasion configuration indicated by the configuration associated with the first uplink carrier is different than a RACH occasion configuration indicated by the configuration associated with the second uplink carrier.

5. The method of claim 1, wherein a resource unit configuration indicated by the configuration associated with the first uplink carrier is different than a resource unit configuration indicated by the configuration associated with the second uplink carrier.

6. (canceled)

7. The method of claim 1, wherein the configurations associated with the respective uplink carriers correspond to respective transmission occasions for the RACH message on the respective uplink carriers.

8. (canceled)

9. The method of claim 1, wherein a preamble of the RACH message and a payload of the RACH message are transmitted with a configurable transmission gap between the preamble and the payload.

10. The method of claim 1, wherein the selection of the selected set of uplink carriers is based at least in part on a payload size, a waveform, or a numerology of the RACH message.

11. (canceled)

12. The method of claim 1, wherein a transmission occasion time offset indicated by the configuration associated with the first uplink carrier is different than a transmission time offset indicated by the configuration associated with the second uplink carrier.

13. The method of claim 1, wherein transmitting the RACH message on the selected set of uplink carriers in accordance with the configuration information further comprises:
transmitting the RACH message and one or more retransmissions of the RACH message on the selected set of uplink carriers.

14. (canceled)

15. The method of claim 1, wherein the selection of the selected set of uplink carriers is based at least in part on at least one of:
a coverage requirement of the UE,
a power class of the UE,
a capability of the UE, or
a traffic pattern of the UE.

16. The method of claim 1, wherein the configuration information indicates a RACH occasion on an uplink carrier, of the respective uplink carriers, that is usable for a two-step RACH procedure.

17. The method of claim 1, wherein the configuration information indicates a RACH occasion on an uplink carrier, of the respective uplink carriers, that is usable for a two-step RACH procedure and a four-step RACH procedure.

18. The method of claim 1, wherein the selected set of uplink carriers is associated with at least one of:
a supplementary uplink (SUL) configuration,
a carrier aggregation configuration, or
a dual-connectivity configuration.

19. The method of claim 1, wherein the selection of the selected set of uplink carriers is based at least in part on a bias applied to a measurement on the respective uplink carriers.

20. The method of claim 19, wherein the bias is:
different for selection of an uplink carrier for transmission of a preamble of the RACH message than for selection of an uplink carrier for transmission of a payload of the RACH message,
carrier-specific,
applied to the measurement based at least in part on the measurement satisfying a condition, or
based at least in part on a table that is signaled to the UE using at least one of system information, radio resource control signaling, or downlink control information.

21-22. (canceled)

23. The method of claim 19, wherein a value of the bias is based at least in part on at least one of:
an uplink carrier frequency of the UE,
a duplexing mode of the UE,
a RACH occasion configuration of the UE,
a resource unit configuration of the UE, or
an interference condition associated with a carrier or cell.

24-25. (canceled)

26. The method of claim 1, wherein a payload of the RACH message includes a first part and a second part, wherein the first part and the second part are transmitted on different uplink carriers.

27-29. (canceled)

30. A method of wireless communication performed by a base station, comprising:
transmitting configuration information identifying configurations associated with respective uplink carriers for a random access channel (RACH) message, wherein a configuration associated with a first uplink carrier, of the respective uplink carriers, is different than a configuration associated with a second uplink carrier of the respective uplink carriers; and
receiving the RACH message on a set of uplink carriers, of the respective uplink carriers, in accordance with the configuration information.

31. The method of claim 30, wherein a preamble and a payload of the RACH message are received on a same carrier of the set of uplink carriers.

32. The method of claim 30, wherein a payload size, a waveform, or a numerology indicated by the configuration associated with the first uplink carrier is different than a payload size, a waveform, or a numerology indicated by the configuration associated with the second uplink carrier.

33. The method of claim 30, wherein a RACH occasion configuration indicated by the configuration associated with the first uplink carrier is different than a RACH occasion configuration indicated by the configuration associated with the second uplink carrier.

34. The method of claim 30, wherein a resource unit configuration indicated by the configuration associated with the first uplink carrier is different than a resource unit configuration indicated by the configuration associated with the second uplink carrier.

35. The method of claim 30, wherein the RACH message includes a preamble and a payload, and wherein a preamble of the RACH message and a payload of the RACH message are received on different carriers of the set of uplink carriers.

36. The method of claim 30, wherein the configurations associated with the respective uplink carriers correspond to respective transmission occasions for the RACH message on the respective uplink carriers.

37. (canceled)

38. The method of claim 30, wherein a preamble of the RACH message and a payload of the RACH message are received with a configurable transmission gap between the preamble and the payload.

39-51. (canceled)

52. A method of wireless communication performed by a user equipment (UE), comprising:
receiving configuration information associated with a plurality of uplink carriers for a random access channel (RACH) message, wherein the RACH message includes a first portion and a second portion;
selecting a set of uplink carriers, of the plurality of uplink carriers, on which to transmit the first portion of the RACH message and the second portion of the RACH message based at least in part on the configuration information, wherein the selection of the selected set of uplink carriers is based at least in part on at least one of:
a coverage requirement of the UE,
a power class of the UE,
a capability of the UE, or
a traffic pattern of the UE; and
transmitting the first portion of the RACH message and the second portion of the RACH message on the selected set of uplink carriers based at least in part on the configuration information.

53. The method of claim 52, wherein a configuration associated with a first uplink carrier, of the respective uplink carriers, is different than a configuration associated with a second uplink carrier of the respective uplink carriers

54. A user equipment (UE) for wireless communication, comprising:
a memory; and
one or more processors operatively coupled to the memory, the memory and the one or more processors configured to:
receive configuration information identifying configurations associated with respective uplink carriers for a random access channel (RACH) message, wherein a configuration associated with a first uplink carrier, of the respective uplink carriers, is different than a configuration associated with a second uplink carrier of the respective uplink carriers;
select a set of uplink carriers, of the respective uplink carriers, on which to transmit the RACH message based at least in part on the configuration information; and
transmit the RACH message on the selected set of uplink carriers in accordance with the configuration information.

55-62. (canceled)

63. The UE of claim 54, wherein the RACH message includes a preamble and a payload, and wherein the preamble and the payload of the RACH message are transmitted on a same carrier of the selected set of uplink carriers.
